(19) United States
(12) Patent Application Publication
(10) Pub. No.: US 2021/0004475 A1
(43) Pub. Date: Jan. 7, 2021

(54) COMPUTER APPARATUS, DATA SHARING SYSTEM, AND DATA ACCESS METHOD

(71) Applicant: NEC Corporation, Tokyo (JP)

(72) Inventor: Ryuta OSHIMO, Tokyo (JP)

(73) Assignee: NEC Corporation, Minato-ku, Tokyo (JP)

(21) Appl. No.: 16/918,263

(22) Filed: Jul. 1, 2020

(30) Foreign Application Priority Data
Jul. 1, 2019 (JP) 2019-123011

(51) Int. Cl. G06F 21/62; G06F 21/60

(52) U.S. Cl. CPC G06F 21/6218; G06F 21/604

(57) ABSTRACT

For acquiring an occupancy right of a data volume, the exclusive control unit records that its own computer apparatus has the occupancy right in exclusive control information stored in a control volume. The exclusive control unit determines whether another computer apparatus has recorded that it has the occupancy right in the exclusive control information. The exclusive control unit acquires the occupancy right when it is determined that another computer apparatus has not recorded that it has the occupancy right in the exclusive control information. When it is determined that another computer apparatus has recorded that it has the occupancy right in the exclusive control information, the exclusive control unit records that the own computer apparatus does not have the occupancy right in the exclusive control information and waits for a random time. The exclusive control unit reacquires the occupancy right after the waiting for the random time.

### INCORPORATION BY REFERENCE

This application is based upon and claims the benefit of priority from Japanese patent application No. 2019-123011, filed on Jul. 1, 2019, the disclosure of which is incorporated herein in its entirety by reference.

### TECHNICAL FIELD

The present disclosure relates to a computer apparatus, a data sharing system, and a data access method.

### BACKGROUND ART

For example, in a High Availability (HA) cluster system, a plurality of computers are connected to a single shared disk device (hereinafter also referred to as a shared disk). In the HA cluster system, a plurality of computers may access data on the shared disk at the same time. In this case, if it is assumed that the file system of the shared disk is accessed only from a single computer, data gets corrupted. To address such a case, a control system for controlling computers to exclusively use (to occupy and use) a shared disk therebetween so that a plurality of computers cannot access the shared disk at the same time is conceivable.

As a control system for exclusively using a shared disk, a system using a Small Computer System Interface (SCSI) Reservation, which is a hardware function, is known. A specific computer among computers that share a shared disk issues an SCSI Reservation to a specific area (hereinafter also referred to as a volume) of the shared disk. If a volume can be reserved, access to the volume from other computers is denied until the reservation is released, and the specific computer can occupy the volume. However, as an SCSI Reservation uses a hardware function, a shared disk having no hardware function cannot use an SCSI Reservation.

Japanese Unexamined Patent Application Publication No. 2014-154077 discloses a system that prevents a double update of shared data. The system disclosed in Japanese Unexamined Patent Application Publication No. 2014-154077 includes two shared data update apparatuses, each of which updates shared data, and a shared data storage device (shared disk) that stores the shared data. The shared disk stores two occupancy flags in partitions different from each other. The two occupancy flags can be communicated only by the respective two shared data update apparatuses. The occupancy flag indicates a state in which access is requested to shared data or a state in which access is not requested to shared data. The shared data update apparatus acquires a dedicated flag for another apparatus and checks whether the acquired dedicated flag indicates a state in which access is requested or a state in which access is not requested. The shared data update apparatus accesses shared data when the other shared data update apparatus is in a state in which access is not requested.

The shared disk further stores a priority flag. The priority flag is a flag for identifying a shared data update apparatus to which a high priority to access the shared data is given. When the shared data update apparatus changes a dedicated flag for the shared data update apparatus itself to a state in which access is requested, the shared data update apparatus checks whether the dedicated flag for another apparatus is in a state in which access is requested. The shared data update apparatus refers to the priority flag when the dedicated flag for the other apparatus is in a state in which access is requested. When the priority flag indicates that the other apparatus has a priority higher than that of the shared data update apparatus itself, the shared data update apparatus returns the dedicated flag for the shared data update apparatus itself to a state in which access is not requested and waits for a predetermined time. By doing so, it is possible to transfer access to the shared disk to another apparatus.

In Japanese Unexamined Patent Application Publication No. 2014-154077, using a dedicated flag stored in a shared disk enables an exclusive use of a shared disk that uses a dedicated flag. Further, the data update apparatus disclosed in Japanese Unexamined Patent Application Publication No. 2014-154077 uses a priority flag, and when another apparatus has a priority higher than that of the data update apparatus itself, the data update apparatus transfers access to shared data to the apparatus having the higher priority. By doing so, it is possible to avoid a deadlock in the event of a conflict between access requests.

Further, Japanese Unexamined Patent Application Publication No. 2014-154077 discloses that an apparatus that has accessed shared data changes a priority flag after the access so that a higher priority is given to another apparatus. By doing so, a higher priority is not continuously given to the same data update apparatus, whereby fairness of access to shared data can be ensured.

However, in Japanese Unexamined Patent Application Publication No. 2014-154077, a priority flag is stored in the same partition as that of shared data. Consequently, the priority flag may be deleted or modified due to, for example, a misoperation by a user. Further, as an initial value of the priority flag is undefined, it is not made clear to which apparatus a higher priority is given when a conflict between access requests has first occurred.

Further, Japanese Unexamined Patent Application Publication No. 2014-154077 discloses that the number of shared data update apparatuses (servers) is not limited to two and that a server cluster system may include three or more servers. However, Japanese Unexamined Patent Application Publication No. 2014-154077 fails to disclose how to control a priority flag when the number of servers is three or more.

For example, assume a case in which a server cluster system includes servers A, B, and C. It is assumed that a priority flag indicates that the server A is a server to which a higher priority is given. At this time, it is assumed that the dedicated flag of the server A indicates a state in which access is not requested, and the servers B and C simultaneously set the dedicated flags thereof to a state in which access is requested. In this case, as a higher priority has not been given to the servers B and C, they return the dedicated flags thereof to a state in which access is not requested and wait for a predetermined time. When the predetermined time has elapsed, the servers B and C again set the dedicated flags thereof to a state in which access is requested. However, as a higher priority has not been given to either of the servers B and C, the servers B and C cannot access shared data.

### SUMMARY

In view of the aforementioned circumstances, an example object of the present disclosure is to provide a computer apparatus, a data sharing system, and a data access method that can arbitrate which server occupies a storage device without using a priority flag even when there are conflicting accesses among a plurality of computer apparatuses that exclusively access the storage device.

In order to solve the aforementioned problem, the present disclosure provides, in a first example aspect, a computer apparatus. The computer apparatus includes: an exclusive control unit configured to acquire, in regard to a storage device having a data volume for storing data and a control volume for storing exclusive control information for exclusively controlling a computer apparatus that accesses the data volume, an occupancy right of the data volume; and an access control unit configured to allow access to the data volume from the computer apparatus when the exclusive control unit has acquired the occupancy right and deny access to the data volume from the computer apparatus when the exclusive control unit has not acquired the occupancy right. In an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that the computer apparatus other than the computer apparatus has not recorded that it has the occupancy right in the exclusive control information, records that the computer apparatus does not have the occupancy right in the exclusive control information when it is determined that the computer apparatus other than the computer apparatus has recorded that it has the occupancy right in the exclusive control information, waits for a random time, and reacquires the occupancy right after the waiting for the random time.

In a second example aspect, the present disclosure provides a data sharing system. The data sharing system includes a plurality of computer apparatuses, and a storage device having a data volume for storing data and a control volume for storing exclusive control information for exclusively controlling a computer apparatus that accesses the data volume. Each of the plurality of computer apparatuses includes an exclusive control unit configured to acquire an occupancy right of the data volume, and an access control unit configured to allow access to the data volume from the computer apparatus when the exclusive control unit has acquired the occupancy right and deny access to the data volume from the computer apparatus when the exclusive control unit has not acquired the occupancy right. In each of the computer apparatuses, in an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that a computer apparatus other than the computer apparatus has not recorded that it has the occupancy right in the exclusive control information, records that the computer apparatus does not have the occupancy right in the exclusive control information when it is determined that a computer apparatus other than the computer apparatus has recorded that it has the occupancy right in the exclusive control information, waits for a random time, and reacquires the occupancy right after the waiting for the random time.

In a third aspect, the present disclosure provides a data access method performed by a computer apparatus. The data access method includes: recording that, in order to acquire, in regard to a storage device having a data volume for storing data and a control volume for storing exclusive control information for exclusively controlling a computer apparatus that accesses the data volume, an occupancy right of the data volume, the computer apparatus has the occupancy right in the exclusive control information; determining whether a computer apparatus other than the computer apparatus has recorded that it has the occupancy right in the exclusive control information; acquiring the occupancy right when it is determined that the computer apparatus other than the computer apparatus has not recorded that it has the occupancy right in the exclusive control information and then allowing access to the data volume from the computer apparatus; and recording that the computer apparatus does not have the occupancy right in the exclusive control information when it is determined that the computer apparatus other than the computer apparatus has recorded that it has the occupancy right in the exclusive control information, waiting for a random time, and reacquiring the occupancy right after the waiting for the random time.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram schematically showing a data sharing system according to the present disclosure;

FIG. 2 is a block diagram showing the data sharing system according to an example embodiment of the present disclosure;

FIG. 3A shows a specific example of an occupancy flag of each server;

FIG. 3B shows a specific example of an occupancy flag of each server;

FIG. 3C shows a specific example of an occupancy flag of each server;

FIG. 3D shows a specific example of an occupancy flag of each server;

FIG. 4 is a flowchart showing an operation procedure at the time of starting access to data;

FIG. 5 is a flowchart showing a procedure of processing for acquiring an occupancy right;

FIG. 6 is a flowchart showing an operation procedure at the end of business operations;

FIG. 7 is a flowchart showing an operation procedure for forcibly releasing the occupancy right; and

FIG. 8 is a block diagram showing an example of a physical configuration of a computer apparatus.

### EMBODIMENTS

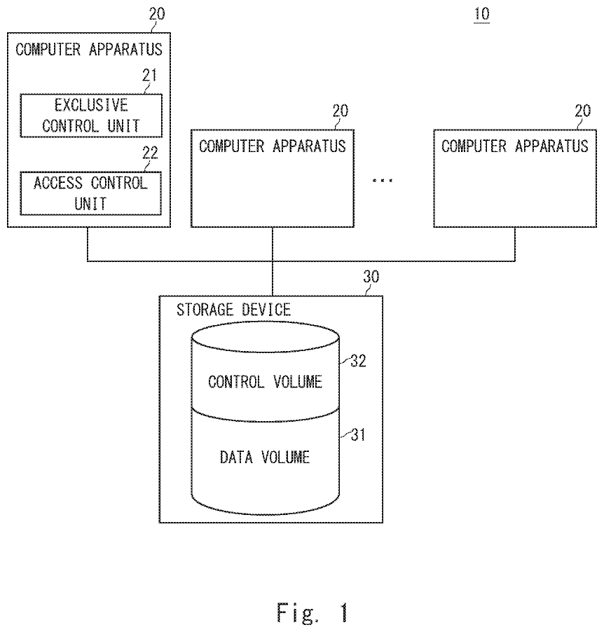

Prior to describing example embodiments according to the present disclosure, an outline of the present disclosure is given. FIG. 1 schematically shows a data sharing system according to the present disclosure. A data sharing system 10 includes a plurality of computer apparatuses 20 and a storage device 30. The storage device 30 has a data volume 31 and a control volume 32. Note that in the present disclosure, the term “volume” refers to a logical volume of a typical Operating System (OS).

The data volume 31 is a volume for storing data. The data volume 31 can be accessed from the plurality of computer apparatuses 20. A computer apparatus that accesses the data volume 31 is exclusively controlled. Only a computer apparatus having an occupancy right, which is an exclusive use right, can access the data volume 31. A computer apparatus having no occupancy right cannot access the data volume 31. The control volume 32 is a volume for storing exclusive control information for exclusively controlling a computer apparatus that accesses the data volume 31.

Each computer apparatus 20 includes an exclusive control unit 21 and an access control unit 22. The exclusive control unit 21 acquires the occupancy right of the data volume 31 of the storage device 30. When the exclusive control unit 21 has acquired the occupancy right, the access control unit 22 allows access from its own apparatus (the computer apparatus including the access control unit 22) to the data volume 31. When the occupancy right has not been acquired, the access control unit 22 denies access to the data volume 31 from the own apparatus.

In an acquisition of the occupancy right, the exclusive control unit 21 records that the own apparatus has the occupancy right in exclusive control information stored in the control volume 32. The exclusive control unit 21 determines whether a computer apparatus other than the own apparatus records that the computer apparatus has the occupancy right in the exclusive control information. When the exclusive control unit 21 determines that the computer apparatus other than the own apparatus has not recorded that the computer apparatus other than the own apparatus has the occupancy right in the exclusive control information, the exclusive control unit 21 successfully acquires the occupancy right.

When the exclusive control unit 21 determines that not only the own apparatus but also a computer apparatus other than the own apparatus have recorded that they have the occupancy right in the exclusive control information, the exclusive control unit 21 records that the own apparatus does not have the occupancy right in the exclusive control information. After that, the exclusive control unit 21 waits for a random time. The exclusive control unit 21 reacquires the occupancy right after the waiting for the random time.

In the present disclosure, the exclusive control unit 21 acquires the occupancy right of the data volume 31 by using exclusive control information stored in the control volume 32 of the storage device 30. The exclusive control unit 21, when two or more computer apparatuses including the own apparatus attempt to acquire the occupancy right, temporarily cancels an acquisition of the occupancy right and waits for a random time. When a computer apparatus other than the own apparatus has acquired the occupancy right during the waiting of the exclusive control unit 21 for the random time, the exclusive control unit 21 cannot acquire the occupancy right. When a computer apparatus other than the own apparatus has acquired no occupancy right during the waiting of the exclusive control unit 21 for the random time, the exclusive control unit 21 can acquire the occupancy right. By doing the above, the present disclosure can arbitrate which server occupies a storage device without using a priority flag even when there are conflicting accesses among a plurality of computer apparatuses 20.

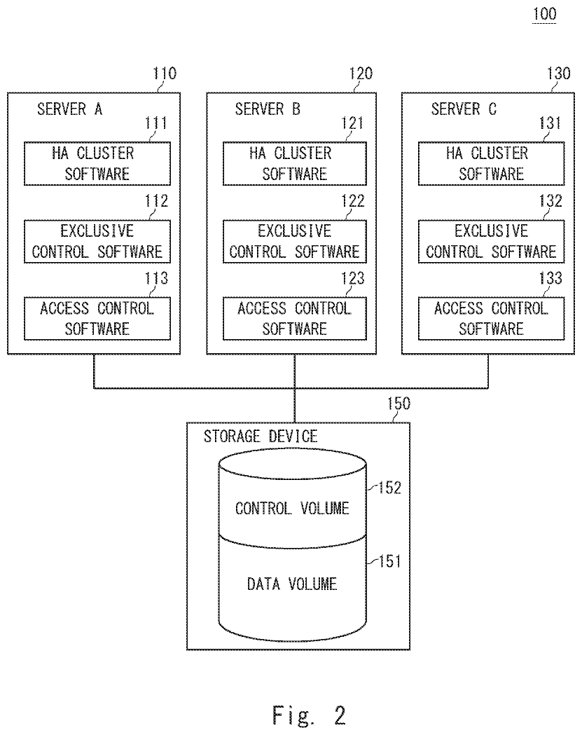

Example embodiments according the present disclosure will be described below in detail with reference to the drawings. FIG. 2 shows a data sharing system according to an example embodiment of the present disclosure. In this example embodiment, the data sharing system is configured as an HA cluster system. An HA cluster system 100 includes a server (a server A) 110, a server (a server B) 120, a server (a server C) 130, and a storage device 150. The HA cluster system 100 corresponds to the data sharing system 10 of FIG. 1. Each of the server A 110, the server B 120, and the server C 130 corresponds to the computer apparatus 20 shown in FIG. 1. The storage device 150 corresponds to the storage device 30 shown in FIG. 1.

The storage device 150 is connected to the servers A 110, B 120, and C 130. The storage device 150 is connected to the servers A 110, B 120, and C 130 via, for example, a Fibre Channel switch. The servers A 110, B 120, and C 130 mutually perform alive monitoring (heartbeat monitoring) via, for example, a network. The HA cluster system 100 is configured by a system of an Active-Standby configuration. In the HA cluster system 100, specific business operations are performed only by a specific server. Data used in business operations is stored in the storage device 150 and shared among the servers A 110, B 120, and C 130. Note that although FIG. 2 shows an example in which the HA cluster system 100 includes three servers, the number of servers is not limited to three and may be any number as long as it is a plural number.

The storage device 150 has a data volume 151 and a control volume 152. The data volume 151 stores data used in business operations. In an initial state, the servers A 110, B 120, and C 130 cannot access the data volume 151. One of the servers A 110, B 120, and C 130 acquires the exclusive use right (hereinafter also referred to as the occupancy right) of the data volume 151. The server that has acquired the occupancy right can exclusively access data stored in the data volume 151. For example, when the server A 110 has acquired the occupancy right, the servers B 120 and C 130 cannot access data stored in the data volume 151. The data volume 151 corresponds to the data volume 31 shown in FIG. 1. The control volume 152 stores exclusive control information for exclusively controlling a server that accesses the data volume 151. In this example embodiment, the exclusive control information includes occupancy flags corresponding to the respective plurality of servers capable of accessing the data volume 151. For example, the control volume 152associates information (e.g., a host name) capable of uniquely identifying each server with a logical value indicating whether or not each server has an occupancy right and stores them as the exclusive control information. For example, the occupancy flag “1” indicates that a server occupies the data volume 151. The occupancy flag “0” indicates that a server does not occupy the data volume 151. In the following description, changing the logical value of the occupancy flag from “0” to “1” can also be referred to as “setting an occupancy flag”. Further, changing the logical value of the occupancy flag from “1” to “0” can also be referred to as “releasing an occupancy flag”. The control volume 152 corresponds to the control volume 32 shown in FIG. 1.

The server A 110 includes HA cluster software 111, exclusive control software 112, and access control software 113. The server B 120 includes HA cluster software 121, exclusive control software 122, and access control software 123. The server C130 includes HA cluster software 131, exclusive control software 132, and access control software 133. The pieces of the HA cluster software 111, 121, and 131 are pieces of software for configuring an HA cluster using the servers A 110, B 120, and C 130. The pieces of the HA cluster software 111, 121, and 131 execute business operations using the data volume 151 as a storage area. Business operations are operated in an Active-Standby configuration, and the business operations are executed by one of the servers A 110, B 120, and C130. A server that executes business operations stores data used for the business operations in the data volume 151. Further, the server that executes business operations reads the data from the data volume 151 and uses it in the business operations. In this example embodiment, it is assumed that the HA cluster software of each server has not started business operations in an initial state. That is, it is assumed that all the servers are in a standby state in the HA cluster system.

The pieces of the exclusive control software 112, 122, and 132 arbitrate which server occupies the data volume 151 of the storage device 150. None of the servers A 110, B 120, and C130 have the occupancy right in an initial state. The pieces of the exclusive control software 112, 122, and 132 perform processing for acquiring the occupancy right for exclusively using the data volume 151, for example, at the start of business operations. In an acquisition of the occupancy right, each of the pieces of the exclusive control software 112, 122, and 132 sets an occupancy flag of its own server stored in the control volume 152. In other words, each of the pieces of the exclusive control software 112, 122, and 132 records that the own server has the occupancy right in the exclusive control information stored in the control volume 152.

Each of the pieces of the exclusive control software 112, 122, and 133 may acquire the occupancy flag of each server from the control volume 152 before setting the occupancy flag of the own server, and determine based on the acquired occupancy flags whether there is a server that has set the occupancy flag. When each of the pieces of the exclusive control software 112, 122, and 133 determines that there is no server that has set the occupancy flag, it may set the occupancy flag of the own server. When each of the pieces of the exclusive control software 112, 122, and 133 determines that a server that has set the occupancy flag already exists, it fails to acquire the occupancy right.

Each of the pieces of the exclusive control software 112, 122, and 132 determines whether a server other than the own server has set the occupancy flag. In other words, each of the pieces of the exclusive control software 112, 122, and 132 determines whether a server other than the own server has recorded that that server has the occupancy right in the exclusive control information. For example, each of the pieces of the exclusive control software 112, 122, and 132 sets the occupancy flag of the own server, and then acquires the occupancy flag of each server from the control volume 152 and determines based on the acquired occupancy flags whether a server other than the own server has set an occupancy flag. Each of the pieces of the exclusive control software 112, 122 and 132 acquires the occupancy right when a server other than the own server does not set the occupancy flag and only the own server has set the occupancy flag.

Each of the pieces of the exclusive control software 112, 122, and 132 releases the occupancy flag when the own server and a server other than the own server has set the occupancy flag. In other words, each of the pieces of the exclusive control software 112, 122, and 132 records that the own server does not have the occupancy right in the exclusive control information stored in the control volume 152. Each of the pieces of the exclusive control software 112, 122 and 132 waits for a random time after the release of the occupancy flag. Each of the pieces of the exclusive control software 112, 122 and 132 reacquires the occupancy right from the beginning after the waiting for the random time. Each of the pieces of the exclusive control software 112, 122, and 132 corresponds to the exclusive control unit 21 shown in FIG. 1.

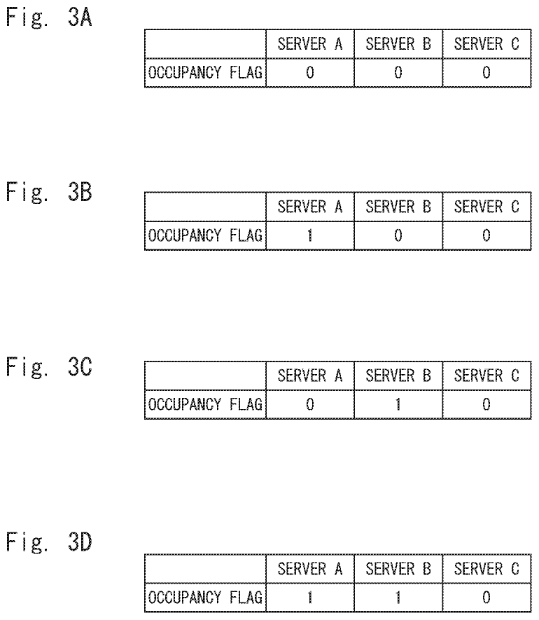

Each of FIGS. 3A to 3D shows a specific example of the occupancy flag of each server. The control volume 152 stores the occupancy flag for each of the servers A, B, and C. As shown in FIG. 3A, the occupancy flag of each of the servers A, B, and C is “0” in an initial state in which no business operations are operated in any of the servers. In this state, no server has the occupancy right, and thus the servers A 110, B 120, and C130 cannot access the data volume 151.

In an acquisition of the occupancy right, the exclusive control software 112 of the server A 110 records “1” in the occupancy flag of the server A. When only the server A 110 acquires the occupancy right, only the occupancy flag of the server A is “1” and the occupancy flags of the servers B and C are both “0” as shown in FIG. 3B. The exclusive control software 112 refers to the occupancy flag to confirm that a server other than the own server has not acquired the occupancy right, and then acquires the occupancy right.

Like the exclusive control software 112 of the server A 110, in an acquisition of the occupancy right, the exclusive control software 122 of the server B 120 records “1” in the occupancy flag of the server B. When only the server B 120 acquires the occupancy right, only the occupancy flag of the server B is “1” and the occupancy flags of the servers A and C are both “0” as shown in FIG. 3C. The exclusive control software 122 refers to the occupancy flag to confirm that a server other than the own server has not acquired the occupancy right, and then acquires the occupancy right. The same applies to the server C 130 in an acquisition of the occupancy right.

When the servers A 110 and B 120 acquire the occupancy right at the same timing, the occupancy flags of the servers A and B may be both “1” as shown in FIG. 3D. When the exclusive control software 112 of the server A 110 recognizes that the occupancy flags of the servers A and B are both “1”, the exclusive control software 112 releases the occupancy flag of the server A in order to transfer the occupancy right to a server other than the own server. Similarly, when the exclusive control software 122 of the server B 120 recognizes that the occupancy flags of the servers A and B are both “1”, the exclusive control software 122 releases the occupancy flag of the server B in order to transfer the occupancy right to a server other than the own server.

Each of the pieces of the exclusive control software 112 and 122 waits for a random time after the release of the occupancy flag. Each of the pieces of the exclusive control software 112 and 122 reacquires the occupancy right after the waiting for the random time. In this case, either the server A 110 or the server B 120, whichever is waiting for a shorter time, can acquire the occupancy right. As the waiting time for each server is random, it is conceivable that the probability the server A 110 can acquire the occupancy right is equal to the probability the server B 120 can acquire. Accordingly, it is conceivable that the server that acquires the occupancy right is not biased to a specific server.

Referring to FIG. 2 again, each of the pieces of the access control software 113, 123, and 133 controls access to the data volume 151. Each of the pieces of the access control software 113, 123, and 133 allows the own server to access the data volume 151 when the own server has acquired the occupancy right. For example, the access control software 113 allows access to the data volume 151 from the server A 110 when the exclusive control software 112 has acquired the occupancy right. Each of the pieces of the access control software 113, 123, and 133 denies access to the data volume 151 from the own server when the own server does not acquire the occupancy right. Each of the pieces of the access control software 113, 123, and 133 corresponds to the access control unit 22 shown FIG. 1.

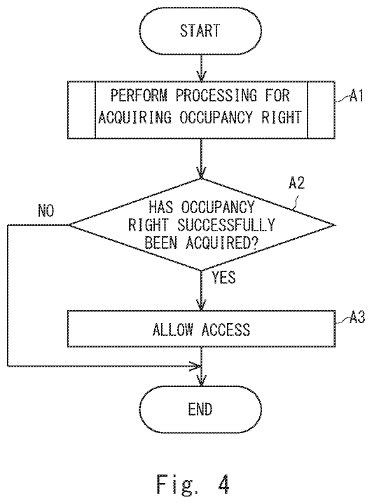

Next, an operation procedure (a data access method) is described. FIG. 4 is a flowchart showing an operation procedure at the time of starting access to data. In the following description, an operation procedure in a case in which the server A 110 starts business operations and the server A 110 accesses the data volume 151 is given. The same operation procedure is applied to the servers B 120 and C 130 when they start business operations. The HA cluster software 111 requests the exclusive control software 112 to acquire the occupancy right. The exclusive control software 112 performs processing for acquiring the occupancy right in order to enable the server A 110 to exclusively use the data volume 151 (Step A1).

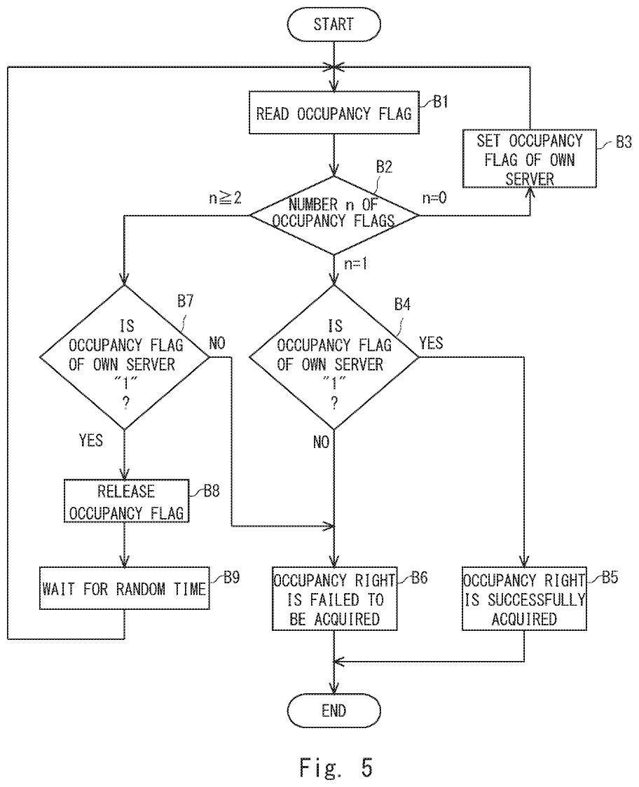

FIG. 5 is a flowchart showing a procedure of the processing for acquiring the occupancy right. An example will be described below in which the exclusive control software 112 of the server A 110 performs the processing for acquiring the occupancy right. The same operation procedure is applied to the exclusive control software 122 of the server B 120 and the exclusive control software 132 of the server C 130 when they perform the processing for acquiring the occupancy right.

The exclusive control software 112 reads the occupancy flags of all the servers from the control volume 152 (Step B1). The exclusive control software 112 checks the number (the number of servers of which the occupancy flag is “1”) n of occupancy flags of which a logical value is “1” (Step B2). The exclusive control software 112 sets the occupancy flag of the own server in order for the own server to acquire the occupancy right when n=0, that is, when no server sets the occupancy flag (Step B3). In Step B3, the exclusive control software 112 sets “1” in the occupancy flag of the own server stored in the control volume 152.

After the exclusive control software 112 sets “1” in the occupancy flag of the own server in Step B3, the process returns to Step B1 and the exclusive control software 112 reads the occupancy flags of all the servers from the control volume 152. Further, in Step B2, the exclusive control software 112 checks the number of servers of which the occupancy flag is “1”. If the process proceeds from Step B3 to Step B2 via Step B1, at least the occupancy flag of the own server is changed to “1”, and the value of n is 1 or larger.

If the exclusive control software 112 determines that n=1 in Step B2, it determines whether the occupancy flag of the own server is “1” (Step B4). In other words, the exclusive control software 112 determines whether only the own server has set the occupancy flag. If the exclusive control software 112 determines that only the own server has set the occupancy flag, it successfully acquires the occupancy right (Step B5). The exclusive control software 112 fails to acquire the occupancy right when the server of which the occupancy flag is “1” is not the own server (Step B6).

If the exclusive control software 112 determines that n>2 in Step B2, it determines whether the occupancy flag of the own server is “1” (Step B7). In other words, the exclusive control software 112 determines whether the own server is included in the two or more servers that have set the occupancy flag. If the exclusive control software 112 determines that the occupancy flag of the own server is not “1” in Step B7, the process proceeds to Step B6 and the exclusive control software 112 fails to acquire the occupancy right.

If the exclusive control software 112 determines that the occupancy flag of the own server is “1” in Step B7, the exclusive control software releases the occupancy flag (Step B8). The exclusive control software 112 waits for a random time after the release of the occupancy flag (Step B9). If a plurality of servers set “1” in their occupancy flags at the same timing, each of the servers of which the occupancy flag is set to “1” releases the occupancy flag and waits for a random time. When the random time has elapsed, the process returns to Step B1 and the exclusive control software 112 reads the occupancy flag from the control volume 152.

A specific operation example is described below. First, in the HA cluster system 100, an operation in a case in which none of the servers A 110, B 120, and C130 has acquired the occupancy right and only the server A 110 performs processing for acquiring the occupancy right is described. In this case, as shown in FIG. 3A, the occupancy flags of the servers are all “0” at the start of the processing for acquiring the occupancy right. In Step B1, the exclusive control software 112 reads the occupancy flag of each server. As the occupancy flags of the servers are all “0”, the process proceeds from Step B2 to Step B3 and the exclusive control software 112 sets the occupancy flag of the own server.

The process returns to Step B1 and the exclusive control software 112 reads the occupancy flags. At this point in time, if a server other than the own server has not performed the processing for acquiring the occupancy right, only the occupancy flag of the server A 110 is “1” as shown in FIG. 3B. In such a case, the exclusive control software 112 determines in Step B2 that the number n of servers of which the occupancy flag is “1” is n=1 and determines in Step B4 that only the occupancy flag of the own server is “1”. In this case, the process proceeds to Step B5 and the exclusive control software 112 successfully acquires the occupancy right.

It is assumed that the server A 110 has acquired the occupancy right and then a server other than the server A 110, for example, the server B 120 starts the processing for acquiring the occupancy right. In Step B1, the exclusive control software 122 of the server B 120 reads the occupancy flags of all the servers from the control volume 152. In Step B2, the exclusive control software 122 determines that the number n of servers of which the occupancy flag is “1” is n=1. Further, in Step B4, the exclusive control software 122 determines that the server of which the occupancy flag is “1” is not the server B 120. In this case, the process proceeds to Step B6 and the exclusive control software 122 fails to acquire the occupancy right.

Next, the operation in a case in which a plurality of servers, for example, the servers A 110 and B 120 start the processing for acquiring the occupancy right almost at the same time in a state in which no server has acquired the occupancy right is described. Such a situation may occur when the network between the servers is fragmented, resulting in an interruption of heartbeat (a network partitioned state), and a plurality of servers attempt to start business operations. In the following description, it is assumed that the server A 110 starts the processing for acquiring the occupancy right, and then the server B 120 starts the processing for acquiring the occupancy right before the acquisition of the occupancy right is determined.

In Step B1, the exclusive control software 112 of the server A 110 reads the occupancy flag of each server. As the occupancy flags of the servers are all “0”, the process proceeds from Step B2 to Step B3 and the exclusive control software 112 sets the occupancy flag of the own server. In Step B1, the exclusive control software 122 of the server B 120 reads the occupancy flag of each server. At this stage, if the occupancy flag of the server A 110 has not yet set to “1”, the process proceeds from Step B2 to Step B3 and the exclusive control software 122 sets the occupancy flag of the own server. As a result, as shown in FIG. 3D, the occupancy flags of the servers A 110 and B 120 are both “1”.

The process returns to Step B1 and the exclusive control software 112 reads the occupancy flags. The exclusive control software 112 determines in Step B2 that the number n of servers of which the occupancy flag is “1” is n=2. The exclusive control software 112 determines that the occupancy flag of the own server is “1” in Step B7 and releases the occupancy flag in Step B8. After the exclusive control software 112 releases the occupancy flag, it waits for a random time in Step B9. At this time, as shown in FIG. 3C, only the occupancy flag of the server B 120 is “1”.

The process returns to Step B1 and the exclusive control software 122 reads the occupancy flags. If the occupancy flag of the server A is released at this point in time, the exclusive control software 122 determines in Step B2 that the number n of servers of which the occupancy flag is “1” is n=1. Further, the exclusive control software 122 determines in Step B4 that only the occupancy flag of the own server is “1”. In this case, the process proceeds to Step B5 and the exclusive control software 122 successfully acquires the occupancy right.

After the exclusive control software 112 of the server A 110 waits for the random time, the process returns to Step B1 and the exclusive control software 112 reads the occupancy flags. If the server B 120 has acquired the occupancy right during the wait of the exclusive control software 112 for the random time, the exclusive control software 112 determines in Step B2 that the number n of servers of which the occupancy flag is “1” is n=1. Further, the exclusive control software 112 determines in Step B4 that the server of which the occupancy flag is “1” is not the server A 110. In this case, the process proceeds to Step B6 and the exclusive control software 112 fails to acquire the occupancy right.

Assume a case in which each of the exclusive control software 112 of the server A 110 and the control software 122 of the server B 120 determines in Step B2 that the number n of servers of which the occupancy flag is “1” is n=2. In this case, each of the pieces of the exclusive control software 112 and 122 determines that the occupancy flag of the own server is “1” in Step B7 and releases the occupancy flag in Step B8. As a result, as shown in FIG. 3A, the occupancy flags of the servers A 110 and B 120 are both “0”.

After the occupancy flag is released, each of the pieces of the exclusive control software 112 and 122 waits for a random time in Step B9. As the waiting time is random, the waiting time for the exclusive control software 112 generally differs from the waiting time for the exclusive control software 122. After the pieces of the exclusive control software 112 and 122 wait for the respective random times, the process returns to Step B1 and the pieces of the exclusive control software 112 and 122 read the occupancy flags. In this case, in the server of which the waiting time is shorter, the process proceeds from Step B2 to Step B3, and the exclusive control software sets “1” in the occupancy flag and then successfully acquires the occupancy right. In the server of which the waiting time is longer, the process proceeds from Step B2 to Step B6 via Step B4, and the exclusive control software fails to acquire the occupancy right.

Referring back to FIG. 4, the exclusive control software 112 determines whether it has successfully acquired the occupancy right (Step A2). If the exclusive control software 112 determines that it has successfully acquired the occupancy right, it causes the access control software 113 to allow access to the data volume 151 from the server A 110 (Step A3). In other words, the exclusive control software 112 causes the access control software 113 to release the interruption of the access to the data volume 151 from the server A 110. Further, if the exclusive control software 112 has successfully acquired the occupancy right, it returns the acquisition of the occupancy right to the HA cluster software 111. The HA cluster software 111 starts business operations on the server A 110. The HA cluster software 111 can access the data volume 151 through the access control software 113.

If the exclusive control software 112 has failed to acquire the occupancy right, it does not cause the access control software 113 to allow access to the data volume 151 from the server A 110. In this case, the access control software 113 maintains the interruption of the access to the data volume 151 from the server A 110. Further, if the exclusive control software 112 has failed to acquire the occupancy right, it returns the acquisition of the occupancy right to the HA cluster software 111. The HA cluster software 111 does not start business operations involving access to the data volume 151.

If the server A 110 has acquired the occupancy right, the access control software 123 and the access control software 133 maintain the interruption of the access to the data volume 151 in the server B 120 and the server C 130, respectively. Accordingly, even if the HA cluster software 121 of the server B 120 and the HA cluster software 131 of the server C 130 attempt to access the data volume 151, the access is denied. In this way, access to the data volume 151 is limited to the server A 110 that has acquired the occupancy right. The server A 110 holds the occupancy right while business operations are operated.

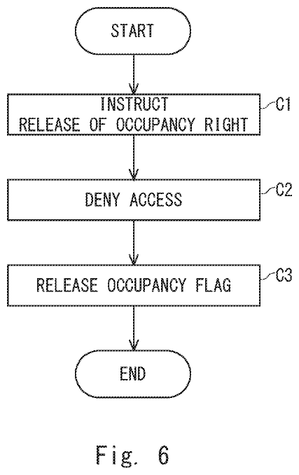

FIG. 6 is a flowchart showing an operation procedure at the end of business operations. Here, assume a case in which business operations operated on the HA cluster software 111 of the server A 110 are terminated. The operation procedure for terminating business operations operated on the HA cluster software 121 of the server B 120 and the HA cluster software 131 of the server C 130 is the same as that for terminating business operations in the server A 110.

If the HA cluster software 111 ends business operations, that is, if the access to data stored in the data volume 151 is ended, the HA cluster software 111 instructs the exclusive control software 112 to release the occupancy right after it ends the business operations operated on the server A 110 (Step C1). If the exclusive control software 112 is instructed to release the occupancy right, it causes the access control software 113 to deny access to the data volume 151 from the own server (Step C2). Further, the exclusive control software 112 releases the occupancy flag of the own server stored in the control volume 152 (Step C3).

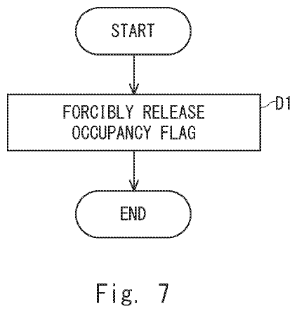

Here, it is conceivable that the occupancy flag is not released and remains “1” when an operation abnormality occurs in a state in which a certain server has acquired the occupancy right. In this case, the occupancy right may be forcibly released from the outside. FIG. 7 shows an operation procedure for forcibly releasing the occupancy right. A user, such as an administrator, releases the occupancy flag of the server that has acquired the occupancy right, which is stored in the control volume 152, by using a server other than the server in which an operation abnormality has occurred (Step D1). For example, when a user uses the server B 120, the exclusive control software 122 releases the occupancy flag of a server other than the server B 120 in accordance with a user operation. By forcibly releasing the occupancy flag, when a server that starts the business operations performs the processing for acquiring the occupancy right, the server can acquire the occupancy right.

Note that when the occupancy flag is forcibly released, there is a possibility that a server that is performing the processing for acquiring the occupancy right at that time and a server that has newly acquired the occupancy right simultaneously access the data volume 151. Simultaneous access can result in data corruption. In order to avoid simultaneous access, it is preferable to, before forcibly releasing the occupancy flag, take measures such as turning off the power of the server that is acquiring the occupancy right or manually disconnecting the server from the data volume 151.

In this example embodiment, the storage device 150 has the control volume 152 for storing exclusive control information. Each server acquires the occupancy right of the data volume 151 by using the exclusive control information stored in the control volume 152. In this example embodiment, a server that accesses the data volume 151 is exclusively controlled by using the control volume 152 of the storage device 150. By doing so, it is possible to exclusively control a server that accesses the data volume 151 even when the storage device 150 does not support an SCSI Reservation. Further, in this example embodiment, exclusive control can be achieved by the combination of software for exclusive control and an OS logical volume, and thus special additional hardware is not required. Therefore, it is possible to achieve exclusive control at a low cost without depending on hardware.

In this example embodiment, the exclusive control software of each server once releases the occupancy flag of the own server and waits for a random time when the own server conflicts with a server other than the own server over an acquisition of the occupancy right. The exclusive control software of each server reacquires the occupancy right when the random time has elapsed. By doing so, even when there are conflicts over the acquisition of the occupancy right among the plurality of servers, it is possible to arbitrate which server occupies the data volume 151 without using special information such as a priority flag.

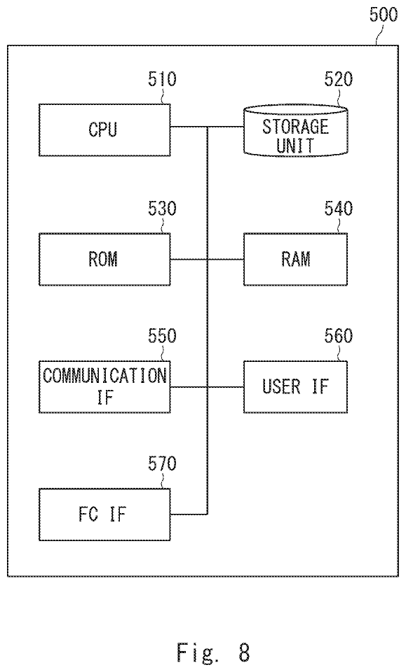

Next, the physical configuration of each server is described. FIG. 8 shows a configuration example of a computer apparatus which can be used as the servers A 110, B 120, and C 130. A computer apparatus 500 includes a Central Processing Unit (CPU) 510, a storage unit 520, a Read Only Memory (ROM) 530, a Random Access Memory (RAM) 540, a communication Interface (IF) 550, a user interface 560, and a Fibre Channel (FC) interface 570.

The communication interface 550 is an interface for connecting the computer apparatus 500 to a communication network via wired communication or wireless communication. The user interface 560 includes a display device such as a display. Further, the user interface 560 also includes input devices such as a keyboard, a mouse, and a touch panel. The fibre channel interface 570 is an interface for connecting the computer apparatus 500 to the storage device 150 (see FIG. 2).

The storage unit 520 is an auxiliary storage device capable of storing various kinds of data. The storage unit 520 is not necessarily a part of the computer apparatus 500 and may be an external storage device or a cloud storage device connected to the computer apparatus 500 via a network. The ROM 530 is a non-volatile storage device. A semiconductor memory device such as a flash memory having a relatively small capacity is used as the ROM 530. The program executed by the CPU 510 can be stored in the storage unit 520 or the ROM 530. The storage unit 520 or the ROM 530 stores various programs including, for example, HA cluster software, exclusive control software, and access control software.

The above-described program(s) can be stored and provided to the computer apparatus 500 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD (compact disc) or DVD (digital versatile disk), and semiconductor memories (such as mask ROM, PROM (programmable ROM), EPROM (erasable PROM), flash ROM, RAM, etc.). Further, the program(s) may be provided to a computer using any type of transitory computer readable media. Examples of transitory computer readable media include electrical signals, optical signals, and electromagnetic waves. Transitory computer readable media can provide the program(s) to a computer via a wired communication line (e.g., electric wires, and optical fibers) or a wireless communication line.

The RAM 540 is a volatile storage device. As the RAM 540, various semiconductor memory devices such as Dynamic Random Access Memory (DRAM) or Static Random Access Memory (SRAM) are used. The RAM 540 can be used as an internal buffer for temporarily storing data or the like. The CPU 510 develops, in the RAM 540, a program stored in the storage unit 520 or the ROM 530 and executes the program. The function of the servers A 110, B 120 or C 130 can be implemented by the CPU 510 executing the program. The CPU 510 may have an internal buffer capable of temporarily storing data or the like.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

(Supplementary Note 1)

A computer apparatus, comprising:

an exclusive control unit configured to acquire, in regard to a storage device having a data volume for storing data and a control volume for storing exclusive control information for exclusively controlling a computer apparatus that accesses the data volume, an occupancy right of the data volume; and

an access control unit configured to allow access to the data volume from the computer apparatus when the exclusive control unit has acquired the occupancy right and deny access to the data volume from the computer apparatus when the exclusive control unit has not acquired the occupancy right, wherein

in an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that the computer apparatus other than the computer apparatus has not recorded that it has the occupancy right in the exclusive control information, records that the computer apparatus does not have the occupancy right in the exclusive control information when it is determined that the computer apparatus other than the computer apparatus has recorded that it has the occupancy right in the exclusive control information, waits for a random time, and reacquires the occupancy right after the waiting for the random time.

(Supplementary Note 2)

The computer apparatus described in Supplementary Note 1, wherein the exclusive control unit acquires the exclusive control information from the control volume prior to recording that the computer apparatus has the occupancy right in the exclusive control information, determines whether there is a computer apparatus which has recorded that it has the occupancy right based on the exclusive control information, and records that the computer apparatus has the occupancy right in the exclusive control information when the exclusive control unit determines that there are no computer apparatuses which have recorded that they have the occupancy right.

(Supplementary Note 3)

The computer apparatus described in Supplementary Note 2, wherein when the exclusive control unit determines that there is a computer apparatus which has recorded that it has the occupancy right, the exclusive control unit fails to acquire the occupancy right.

(Supplementary Note 4)

The computer apparatus described in Supplementary Note 2 or 3, wherein the exclusive control unit checks the number of computer apparatuses which have recorded that they have the occupancy right in the exclusive control information and determines that there are no computer apparatuses which have recorded that they have the occupancy right when the number of computer apparatuses which have recorded that they have the occupancy right in the exclusive control information is zero.

(Supplementary Note 5)

The computer apparatus described in any one of Supplementary Notes 1 to 4, wherein the exclusive control unit records that the computer apparatus has the occupancy right in the exclusive control information, and then acquires the exclusive control information from the control volume and determines based on the acquired exclusive control information whether a computer apparatus other than the computer apparatus has recorded that it has the occupancy right in the exclusive control information.

(Supplementary Note 6)

The computer apparatus described in any one of Supplementary Notes 1 to 5, wherein the exclusive control unit checks the number of computer apparatuses which have recorded that they have the occupancy right in the exclusive control information and determines that the computer apparatus other than the computer apparatus has not recorded that it has the occupancy right in the exclusive control information when the number of computer apparatuses which have recorded that they have the occupancy right in the exclusive control information is one and the computer apparatus has recorded that it has the occupancy right in the exclusive control information.

(Supplementary Note 7)

The computer apparatus described in Supplementary Note 6, wherein the exclusive control unit fails to acquire the occupancy right when the number of computer apparatuses which have recorded that they have the occupancy right in the exclusive control information is one and the computer apparatus has not recorded that it has the occupancy right in the exclusive control information.

(Supplementary Note 8)

The computer apparatus described in any one of Supplementary Notes 1 to 7, wherein the exclusive control unit checks the number of computer apparatuses which have recorded that they have the occupancy right in the exclusive control information and determines that the computer apparatus other than the computer apparatus has recorded that it has the occupancy right in the exclusive control information when the number of computer apparatuses which have recorded that they have the occupancy right in the exclusive control information is two or more and the computer apparatus has recorded that it has the occupancy right in the exclusive control information.

(Supplementary Note 9)

The computer apparatus described in Supplementary Note 8, wherein the exclusive control unit fails to acquire the occupancy right when the number of computer apparatuses which have recorded that they have the occupancy right in the exclusive control information is two or more and the computer apparatus has not recorded that it has the occupancy right in the exclusive control information.

(Supplementary Note 10)

The computer apparatus described in any one of Supplementary Notes 1 to 9, wherein

the exclusive control information includes an occupancy flag corresponding to each of a plurality of computer apparatuses capable of accessing the data volume, and

the exclusive control unit records, in the occupancy flag corresponding to the computer apparatus, information indicating whether or not the computer apparatus has the occupancy right.

(Supplementary Note 11)

The computer apparatus described in any one of Supplementary Notes 1 to 10, wherein the exclusive control unit, when access to the data is ended, records that the computer apparatus does not have the occupancy right in the exclusive control information and causes the access control unit to deny access to the data volume from the computer apparatus.

(Supplementary Note 12)

The computer apparatus described in any one of Supplementary Notes 1 to 11, wherein the exclusive control unit rewrites, in accordance with a user operation, information indicating that the computer apparatus other than the computer apparatus has the occupancy right, which is recorded in the exclusive control information, to information indicating that the computer apparatus other than the computer apparatus does not have the occupancy right.

(Supplementary Note 13)

A data sharing system comprising:

a plurality of computer apparatuses; and

a storage device having a data volume for storing data and a control volume for storing exclusive control information for exclusively controlling a computer apparatus that accesses the data volume, wherein

each of the plurality of computer apparatuses comprises an exclusive control unit configured to acquire an occupancy right of the data volume, and an access control unit configured to allow access to the data volume from the computer apparatus when the exclusive control unit has acquired the occupancy right and deny access to the data volume from the computer apparatus when the exclusive control unit has not acquired the occupancy right, and

in each of the computer apparatuses, in an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that the computer apparatus other than the computer apparatus has not recorded that it has the occupancy right in the exclusive control information, records that the computer apparatus does not have the occupancy right in the exclusive control information when it is determined that the computer apparatus other than the computer apparatus has recorded that it has the occupancy right in the exclusive control information, waits for a random time, and reacquires the occupancy right after the waiting for the random time.

(Supplementary Note 14)

The data sharing system described in Supplementary Note 13, wherein the exclusive control unit acquires the exclusive control information from the control volume prior to recording that the computer apparatus has the occupancy right in the exclusive control information, determines whether there is a computer apparatus which has recorded that it has the occupancy right based on the exclusive control information, and records that the computer apparatus has the occupancy right in the exclusive control information when the exclusive control unit determines that there are no computer apparatuses which have recorded that they have the occupancy right.

(Supplementary Note 15)

The data sharing system described in Supplementary Note 13 or 14, wherein the exclusive control unit records that the computer apparatus has the occupancy right in the exclusive control information, and then acquires the exclusive control information from the control volume and determines based on the acquired exclusive control information whether a computer apparatus other than the computer apparatus has recorded that it has the occupancy right in the exclusive control information.

(Supplementary Note 16)

A data access method performed by a computer apparatus, the data access method comprising:

recording that, in order to acquire, in regard to a storage device having a data volume for storing data and a control volume for storing exclusive control information for exclusively controlling a computer apparatus that accesses the data volume, an occupancy right of the data volume, the computer apparatus has the occupancy right in the exclusive control information;

determining whether a computer apparatus other than the computer apparatus has recorded that it has the occupancy right in the exclusive control information;

acquiring the occupancy right when it is determined that the computer apparatus other than the computer apparatus has not recorded that it has the occupancy right in the exclusive control information and then allowing access to the data volume from the computer apparatus; and

recording that the computer apparatus does not have the occupancy right in the exclusive control information when it is determined that the computer apparatus other than the computer apparatus has recorded that it has the occupancy right in the exclusive control information, waiting for a random time, and reacquiring the occupancy right after the waiting for the random time.

(Supplementary Note 17)

A program causing, when it is executed in a computer apparatus, the computer apparatus to:

record that, in order to acquire, in regard to a storage device having a data volume for storing data and a control volume for storing exclusive control information for exclusively controlling a computer apparatus that accesses the data volume, an occupancy right of the data volume, the computer apparatus has the occupancy right in the exclusive control information;

determine whether a computer apparatus other than the computer apparatus has recorded that it has the occupancy right in the exclusive control information;

acquire the occupancy right when it is determined that the computer apparatus other than the computer apparatus has not recorded that it has the occupancy right in the exclusive control information and then allow access to the data volume from the computer apparatus; and

record that the computer apparatus does not have the occupancy right in the exclusive control information when it is determined that the computer apparatus other than the computer apparatus has recorded that it has the occupancy right in the exclusive control information, wait for a random time, and reacquire the occupancy right after the waiting for the random time.

What is claimed is:

1. A computer apparatus, comprising:
an exclusive control unit configured to acquire, in regard to a storage device having a data volume for storing data and a control volume for storing exclusive control information for exclusively controlling a computer apparatus that accesses the data volume, an occupancy right of the data volume; and
an access control unit configured to allow access to the data volume from the computer apparatus when the exclusive control unit has acquired the occupancy right and deny access to the data volume from the computer apparatus when the exclusive control unit has not acquired the occupancy right, wherein in an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that the computer apparatus other than the computer apparatus has not recorded that it has the occupancy right in the exclusive control information, records that the computer apparatus does not have the occupancy right in the exclusive control information when it is determined that the computer apparatus other than the computer apparatus has recorded that it has the occupancy right in the exclusive control information, waits for a random time, and reacquires the occupancy right after the waiting for the random time.

2. The computer apparatus according to claim 1, wherein the exclusive control unit acquires the exclusive control information from the control volume prior to recording that the computer apparatus has the occupancy right in the exclusive control information, determines whether there is a computer apparatus which has recorded that it has the occupancy right based on the exclusive control information, and records that the computer apparatus has the occupancy right in the exclusive control information when the exclusive control unit determines that there are no computer apparatuses which have recorded that they have the occupancy right.

3. The computer apparatus according to claim 2, wherein when the exclusive control unit determines that there is a computer apparatus which has recorded that it has the occupancy right, the exclusive control unit fails to acquire the occupancy right.

4. The computer apparatus according to claim 2, wherein the exclusive control unit checks the number of computer apparatuses which have recorded that they have the occupancy right in the exclusive control information and determines that there are no computer apparatuses which have recorded that they have the occupancy right when the number of computer apparatuses which have recorded that they have the occupancy right in the exclusive control information is zero.

5. The computer apparatus according to claim 1, wherein the exclusive control unit records that the computer apparatus has the occupancy right in the exclusive control information, and then acquires the exclusive control information from the control volume and determines based on the acquired exclusive control information whether a computer apparatus other than the computer apparatus has recorded that it has the occupancy right in the exclusive control information.

6. The computer apparatus according to claim 1, wherein the exclusive control unit checks the number of computer apparatuses which have recorded that they have the occupancy right in the exclusive control information and determines that the computer apparatus other than the computer apparatus has not recorded that it has the occupancy right in the exclusive control information when the number of computer apparatuses which have recorded that they have the occupancy right in the exclusive control information is one and the computer apparatus has recorded that it has the occupancy right in the exclusive control information.

7. The computer apparatus according to claim 6, wherein the exclusive control unit fails to acquire the occupancy right when the number of computer apparatuses which have recorded that they have the occupancy right in the exclusive control information is one and the computer apparatus has not recorded that it has the occupancy right in the exclusive control information.

8. The computer apparatus according to claim 1, wherein the exclusive control unit checks the number of computer apparatuses which have recorded that they have the occupancy right in the exclusive control information and determines that the computer apparatus other than the computer apparatus has recorded that it has the occupancy right in the exclusive control information when the number of computer apparatuses which have recorded that they have the occupancy right in the exclusive control information is two or more and the computer apparatus has recorded that it has the occupancy right in the exclusive control information.

9. The computer apparatus according to claim 8, wherein the exclusive control unit fails to acquire the occupancy right when the number of computer apparatuses which have recorded that they have the occupancy right in the exclusive control information is two or more and the computer apparatus has not recorded that it has the occupancy right in the exclusive control information.

10. The computer apparatus according to claim 1, wherein
the exclusive control information includes an occupancy flag corresponding to each of a plurality of computer apparatuses capable of accessing the data volume, and
the exclusive control unit records, in the occupancy flag corresponding to the computer apparatus, information indicating whether or not the computer apparatus has the occupancy right.

11. The computer apparatus according to claim 1, wherein the exclusive control unit, when access to the data is ended, records that the computer apparatus does not have the occupancy right in the exclusive control information and causes the access control unit to deny access to the data volume from the computer apparatus.

12. The computer apparatus according to claim 1, wherein the exclusive control unit rewrites, in accordance with a user operation, information indicating that the computer apparatus other than the computer apparatus has the occupancy right, which is recorded in the exclusive control information, to information indicating that the computer apparatus other than the computer apparatus does not have the occupancy right.

13. A data sharing system comprising:
a plurality of computer apparatuses; and
a storage device having a data volume for storing data and a control volume for storing exclusive control information for exclusively controlling a computer apparatus that accesses the data volume, wherein
each of the plurality of computer apparatuses comprises an exclusive control unit configured to acquire an occupancy right of the data volume, and an access control unit configured to allow access to the data volume from the computer apparatus when the exclusive control unit has acquired the occupancy right and deny access to the data volume from the computer apparatus when the exclusive control unit has not acquired the occupancy right, and
in each of the computer apparatuses, in an acquisition of the occupancy right, the exclusive control unit records that the computer apparatus has the occupancy right in the exclusive control information, determines whether a computer apparatus other than the computer apparatus has recorded that it has the occupancy right in the exclusive control information, acquires the occupancy right when it is determined that the computer apparatus other than the computer apparatus has not recorded that it has the occupancy right in the exclusive control information, records that the computer apparatus does not have the occupancy right in the exclusive control information when it is determined that the computer apparatus other than the computer apparatus has recorded that it has the occupancy right in the exclusive control information, waits for a random time, and reacquires the occupancy right after the waiting for the random time.

14. The data sharing system according to claim 13, wherein the exclusive control unit acquires the exclusive control information from the control volume prior to recording that the computer apparatus has the occupancy right in the exclusive control information, determines whether there is a computer apparatus which has recorded that it has the occupancy right based on the exclusive control information, and records that the computer apparatus has the occupancy right in the exclusive control information when the exclusive control unit determines that there are no computer apparatuses which have recorded that they have the occupancy right.

15. The data sharing system according to claim 13, wherein the exclusive control unit records that the computer apparatus has the occupancy right in the exclusive control information, and then acquires the exclusive control information from the control volume and determines based on the acquired exclusive control information whether a computer apparatus other than the computer apparatus has recorded that it has the occupancy right in the exclusive control information.

16. A data access method performed by a computer apparatus, the data access method comprising:
recording that, in order to acquire, in regard to a storage device having a data volume for storing data and a control volume for storing exclusive control information for exclusively controlling a computer apparatus that accesses the data volume, an occupancy right of the data volume, the computer apparatus has the occupancy right in the exclusive control information;
determining whether a computer apparatus other than the computer apparatus has recorded that it has the occupancy right in the exclusive control information;
acquiring the occupancy right when it is determined that the computer apparatus other than the computer apparatus has not recorded that it has the occupancy right in the exclusive control information and then allowing access to the data volume from the computer apparatus; and
recording that the computer apparatus does not have the occupancy right in the exclusive control information when it is determined that the computer apparatus other than the computer apparatus has recorded that it has the occupancy right in the exclusive control information, waiting for a random time, and reacquiring the occupancy right after the waiting for the random time.
